(19) United States
(12) Patent Application Publication
(10) Pub. No.: US 2010/0205190 A1
(43) Pub. Date: Aug. 12, 2010

(54) SURFACE-BASED COLLABORATIVE SEARCH

(75) Inventors: Meredith J. Morris, Bellevue, WA (US); Stephen Edward Hodges, Cambridge (GB); Ian C. LeGrow, Redmond, WA (US); William J. Westerinen, Sammamish, WA (US); Andrew D. Wilson, Seattle, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/367,734

(22) Filed: Feb. 9, 2009

(51) Int. Cl. G06F 17/30; G06F 3/041

(52) U.S. Cl. 707/758; 345/173; 707/E17.108

(57) ABSTRACT

The claimed subject matter relates to architectures that can provide rich features associated with information-based collaborative searches by leveraging a multi-touch surface computing-based display. In particular, a first architecture can include a multi-touch surface configured to support interactivity with multiple collocated users simultaneously. Based upon such interaction, the first architecture can transmit to a search engine a multiuser surface identifier and a set of search terms input by collocated users that share a collaborative task. In response, the architecture can receive a set of search results from a second architecture, and present those results to the multi-touch surface in a variety of ways. The second architecture can relate to a search engine that can process the search terms to generate corresponding search results and also process information associated with the multiuser surface identifier.

### CROSS-REFERENCE TO RELATED APPLICATIONS

This application is related to U.S. patent application Ser. No. (MSFTP2440US) ______, filed on ______, entitled, “COMPOSABLE SURFACES.” The entireties of these applications are incorporated herein by reference.

### BACKGROUND

Today, most computing devices, whether stationary or mobile device, utilize some form of display screen or surface as a user-interface (UI) component. Often these displays are merely output only devices, while a growing number utilize touch-sensitive screens for interactivity and/or input functionality. Recent technological advances both in terms of user-interfaces as well as display surfaces have sparked a growing evolution toward surface computing. In the domain of surface computing, the associated displays are generally touch-sensitive screens of substantially any form factor that often forego many traditional I/O devices such as a keyboard or mouse in favor of tactile-based manipulation. In order to compensate for this transition, computing surfaces can be implemented as multi-touch surfaces.

Due to the growing interest in surface computing, new techniques or technologies can be implemented or leveraged in order to enhance functionality, increase productivity, and/or enrich user experiences.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one or more aspects thereof, comprises various architectures that can leverage a multi-touch surface computing-based display to provide rich collaborative search features. In accordance therewith and to other related ends, one architecture can include a multi-touch surface that is configured to support interactivity with multiple collocated users simultaneously or concurrently. The architecture can transmit to a second architecture (e.g., a suitable search engine) a multiuser surface identifier as well as a set of search terms. In response, the architecture can receive from the second architecture a set of search results that correspond to the set of search terms, which can be presented by way of the multi-touch surface.

The multiuser surface identifier can be a flag or tag, potentially included in the set of search terms that indicates a collaborative query is being performed on a multi-touch surface. In addition, the multiuser surface identifier can include an indication of an origin for each term from the set of search terms such as which search terms were input by respective collaborative users, an indication of a current number of collocated or collaborative users, a surface feature or specification, or the like. The second architecture can employ the multiuser surface identifier in order to select or organize the set of search results based at least in part on the indication of origin for the search terms.

In addition, the architecture can allocate individual portions of the multi-touch surface to each of the collocated users based upon an associated position around the multi-touch surface occupied by each of the collocated users, respectively; and/or based upon a user ID associated with each of the collocated users, respectively. Moreover, the architecture can provide a unique orientation for user-interface features (e.g., objects, documents, diagrams . . . ) associated with each portion of the multi-touch surface. Hence, all collocated users need not be constrained by a single display orientation.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a computer-implemented system that can leverage a multi-touch surface computing-based display to provide rich search features.

FIG. 2 depicts a block diagram of a system that can provide a variety of features in connection with a collaborative search on a multi-touch surface.

FIG. 3 depicts a block diagram of a system that can provide a variety of features in connection with a collaborative search on a portion of a multi-touch surface.

FIG. 4 illustrates a block diagram of a system that can facilitate assignment of suitable roles and/or provide suitable templates for presenting results.

FIG. 5 is a block diagram of a network-accessible search engine system that can leverage client-side capabilities including at least a collaborative search on a multi-touch surface in order to provide rich search results.

FIG. 6 is a block diagram of a system that can provide for or aid with various inferences or intelligent determinations.

FIG. 7 depicts an exemplary flow chart of procedures that define a method for enriching collaborative searching features by leveraging a multi-touch surface display.

FIG. 8 illustrates an exemplary flow chart of procedures that define a method for apportioning the multi-touch surface and/or additional features associated with presenting results.

FIG. 9 depicts an exemplary flow chart of procedures defining a method for providing addition features in connection with enriching surface-based collaborative searching.

FIG. 10 illustrates a block diagram of a computer operable to execute the disclosed architecture.

FIG. 11 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can, but need not, refer to a computer-related entity, either hardware, a combination of hardware and software, software, or software in execution. For example, a component might be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” Therefore, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” generally refer to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

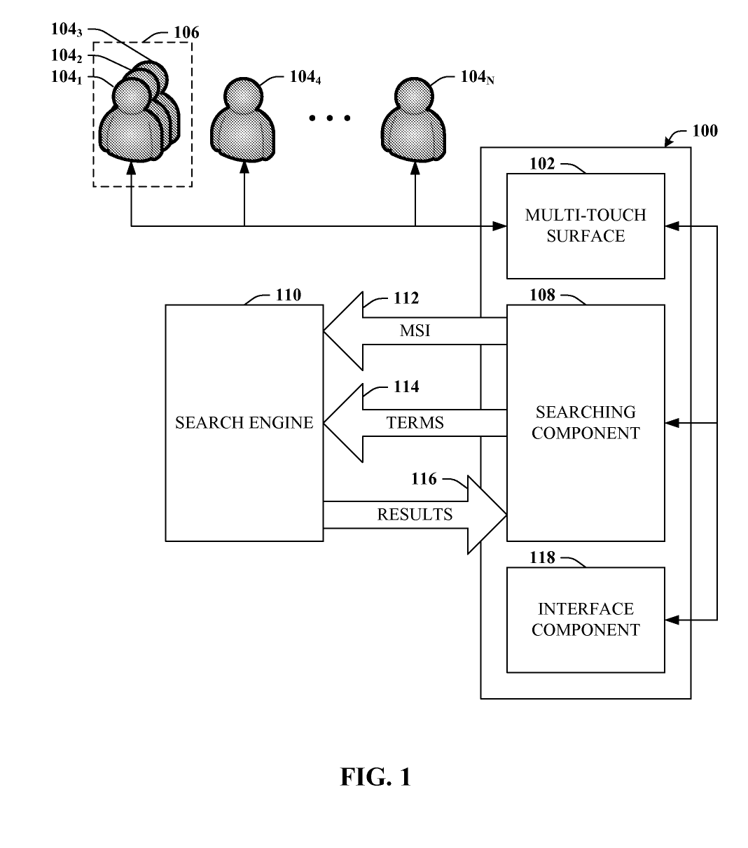

Referring now to the drawings, with reference initially to FIG. 1, computer-implemented system 100 that can leverage a multi-touch surface computing-based display to provide robust search features is depicted. For example, rich features associated with collaborative search queries can be provided. Generally, system 100 can include multi-touch surface 102 that can be configured to support interactivity with multiple collocated users 104₁-104_{N} simultaneously. Multiple collocated users 104₁-104_{N} can include substantially any number, N, users and is referred to herein either collectively or individually as collocated user(s) 104, with individual subscripts typically employed only when necessary to distinguish or avoid confusion. Multi-touch surface 102 can be embodied as a desk or tabletop, a wall, a billboard, sign or kiosk, a device display or the like, and can include a touch-sensitive screen or another surface that can recognize multiple simultaneous touch points. Accordingly, multi-touch surface 102 can identify interactions from multiple fingers (or other objects or devices), from multiple hands, as well as from multiple collocated users 104, all potentially simultaneously. Existing multi-touch surfaces employ a variety of detection-based mechanisms or techniques for recognizing contact, such as heat, pressure, cameras, infrared radiation, optic capture, tuned electromagnetic induction, ultrasonic receivers, transducer microphones, rangefinders, shadow capture, and so on. Appreciably, any of the aforementioned known techniques can be employed in connection with the claimed subject matter as well as other suitable techniques or technologies.

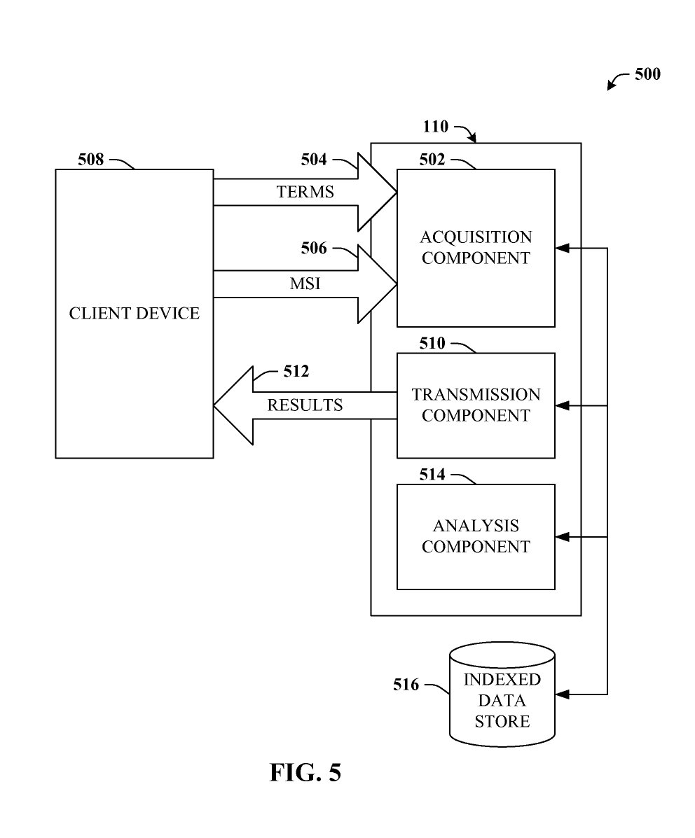

In addition, system 100 can also include searching component 108 that can transmit various information to search engine 110, an example of which is provided in connection with FIG. 5, infra. The information transmitted to search engine 110 by searching component 108 can include, e.g., multiuser surface identifier 112 and set 114 of search terms input by or on behalf of collaborative users 106. Collaborative users 106 can be or represent all or a portion of collocated users 104, but can be distinguished for the purposes of this disclosure as collocated users 104 who share a common task or objective, often in connection with multi-touch surface 102 or a search query. Accordingly, in one or more aspects of the claimed subject matter, each search term from set 114 of search terms can relate to a collaborative task shared by all collaborative users 106. Furthermore, searching component 108 can receive set 116 of search results that correspond to set 114 of search terms from search engine 110.

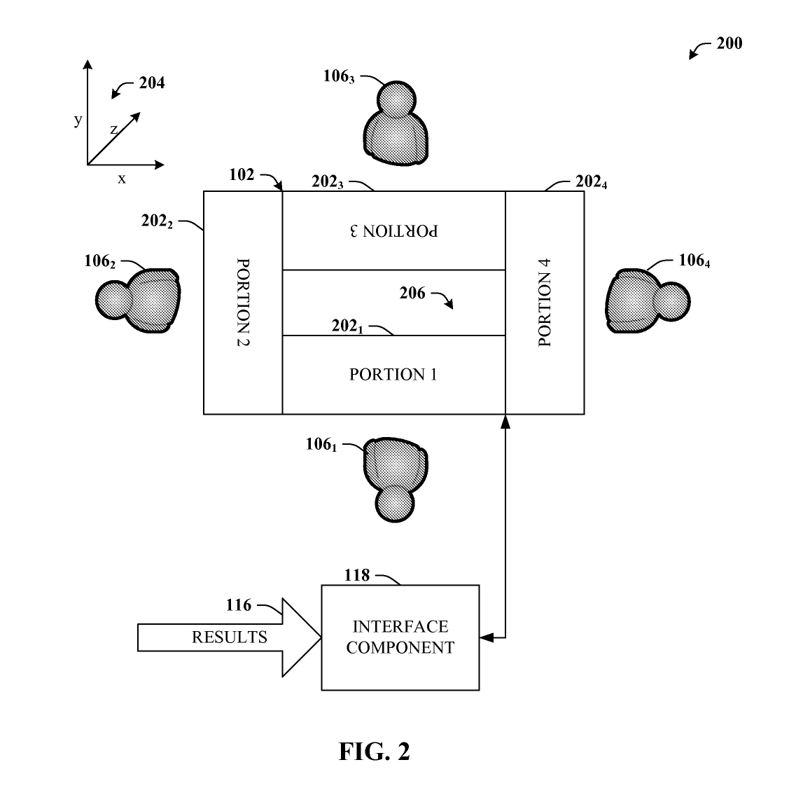

Multiuser search identifier 112 can be transmitted to search engine 110 independently, but can also be included in or bundled with one or more transmission associated with set 114 of search terms. For example, multiuser search identifier 112 can be a flag or tag that indicates a collaborative query is occurring, or otherwise requested or designated. In addition, multiuser search identifier 112 can indicate that the collaborative query is occurring on a multi-touch surface (e.g., multi-touch surface 102), or various other relevant features associated with multi-touch surface 102 such as relevant specification data, the number of collocated users 104 and/or collaborative users 106. In one or more aspects of the claimed subject matter, multiuser surface identifier 112 can further identify a particular portion of multi-touch surface 102 or a user ID associated with each term from set 114 of search terms, both of which are further detailed infra in connection with FIG. 2.

Moreover, system 100 can also include interface component 118 that can mange user interface or interaction with multi-touch surface 102. For example, interface component 118 can present set 116 of search results by way of multi-touch surface 102. Additional features or aspects of interface component 118 are further detailed with reference to FIG. 2.

While still referencing FIG. 1, but turning as well to FIG. 2, system 200 that can provide a variety of features in connection with a collaborative search on a multi-touch surface is illustrated. Depicted is an example multi-touch surface 102 with four collaborative users 106 (denoted 106₁-106₄) situated at various physical locations around multi-touch surface 102, which in this example is representative of an interactive tabletop. Appreciably, multi-touch surface 102 could also accommodate other users such as collocated users 104, e.g. users who are present but not necessarily a part of the collaborative task that involves collaborative users 106. Moreover, although not depicted, some users can be remote who provide inputs or contributions by way of a remote device. These contributions can be integrated with the endeavors of collocated users 104 and presented through a proxy on multi-touch surface 102. However, in the interest of simplicity and ease of explanation, only four collaborative users 106 are depicted, each at a natural or comfortable location around multi-touch surface 102. It should be appreciated that the topology or organization of collaborative users 106 provided here is merely exemplary and numerous other arrangements for users 104 or 106 are envisioned or could otherwise exist. For instance, collocated 104 or collaborative users 106 could be side-by-side, or in a line or tiered in substantially any conceivable manner. Also included in system 200 is interface component 118 that can present results 116 as substantially described supra.

In addition to what has been described above, interface component 118 can allocate one or more portions 202 of multi-touch surface 102 to each collocated user 104 or, in this case, to each collaborative user 106. Hence, interface component 118 can allocate portion 202₁ to collaborative user 1061, portion 202₂ to collaborative user 106₂, and so on around multi-touch surface 102. In one or more aspects, interface component 118 can allocate portion 202 based upon an associated position around multi-touch surface 102 occupied by each collocated user 104 (or collaborative user 106), respectively. For example, each collaborative user 106 can select predefined portions based upon geographic proximity, e.g., by simply touching or otherwise activating the portion 202. Additionally or alternatively, collaborative user 106 can trace out a suitable portion 202 with tactile or gesture-based interactivity with multi-touch surface 102 that substantially defines the boundaries of an associated portion 202.

In one or more aspects, potentially in combination with the above, interface component 118 can also allocate (or at least identify) portion 202 based upon a user ID associated with each user 104, 106, respectively. Hence, in addition to understanding where collaborative users 106 are situated around multi-touch surface 102, the identities of those users 106 can be discovered as well. ID-based recognition can be accomplished based upon a login feature or another type of authentication such as swiping a card or fob and so forth. Appreciably, given the wide assortment of suitable surfaces (e.g., multi-touch surface 102), as well as a potentially unlimited number and arrangements of collocated users 104 who can interact with a given surface, it can be readily appreciated that users 104, 106 can benefit from a personalized orientation 204 of user-interface objects or features that applies to his or her own portion 202. Such can be beneficial over attempting to interact with multi-touch surface 102 in a manner in which objects, documents, or other features appear sideways or upside-down to a given user 106. In accordance therewith, interface component 118 can further provide a unique orientation 204 for user-interface features associated with each allocated portion 202 of multi-touch surface 102. Moreover, in the case in which a user ID is known, associated settings or preferences can be applied, potentially retrieved from a network or cloud or from an associated device (e.g., phone or ID fob, etc.).

Each particular orientation 204 can be based upon a position of the associated collaborative user around multi-touch surface 102 and/or can be defined or established by tactile or gesture-based operations when interfacing with multi-touch surface 102 or selecting or defining portion 202. It should be appreciated that portions 202 or other areas of multi-touch surface 102 can be individually tiltable to change the viewing angle or entirely detachable from the underlying surface in a manner described herein in connection with subject matter incorporated by reference. Furthermore, interface component 118 can maintain a public, communal, or shared portion 206, depicted here in the center of multi-touch surface 102. Shared portion 206 can be maintained based upon a single orientation 204 or display features according to multiple orientations 204 (e.g., one for each portion 202), potentially replicated data for each orientation 204.

In one or more aspects, interface component 118 can automatically display or present a distinct subset of search results 116 to various portions 202 of multi-touch surface 102 based upon distinct search terms provided by associated collaborative users 106. For example, an owner or originator of each search term 114 can be tracked by multiuser surface identifier 112, introduced supra. Appreciably, searching component 108 can transmit set 114 of search terms to search engine 110 with search terms provided by different collocated users 104, even though the entire set 114 can be transmitted together. Moreover, searching component 108 can apply suitable set operators such as unions, intersections, conjoins or the like to various search terms from the set 114 prior to transmission to search engine 110. Regardless, the results can be later distributed to the appropriate portion 202 based upon the unique combination of search terms 114 provided by each associated user 106. Moreover, searching component 108 can highlight, reorder, or otherwise annotate set 116 of search results. For instance, highlighting, reordering to obtain a higher priority, or certain annotations can be applied to hits or results that correspond to search terms submitted by more than one collaborative user 106. Appreciably, such overlapping results can be of particular interest to the group of collaborative users 106.

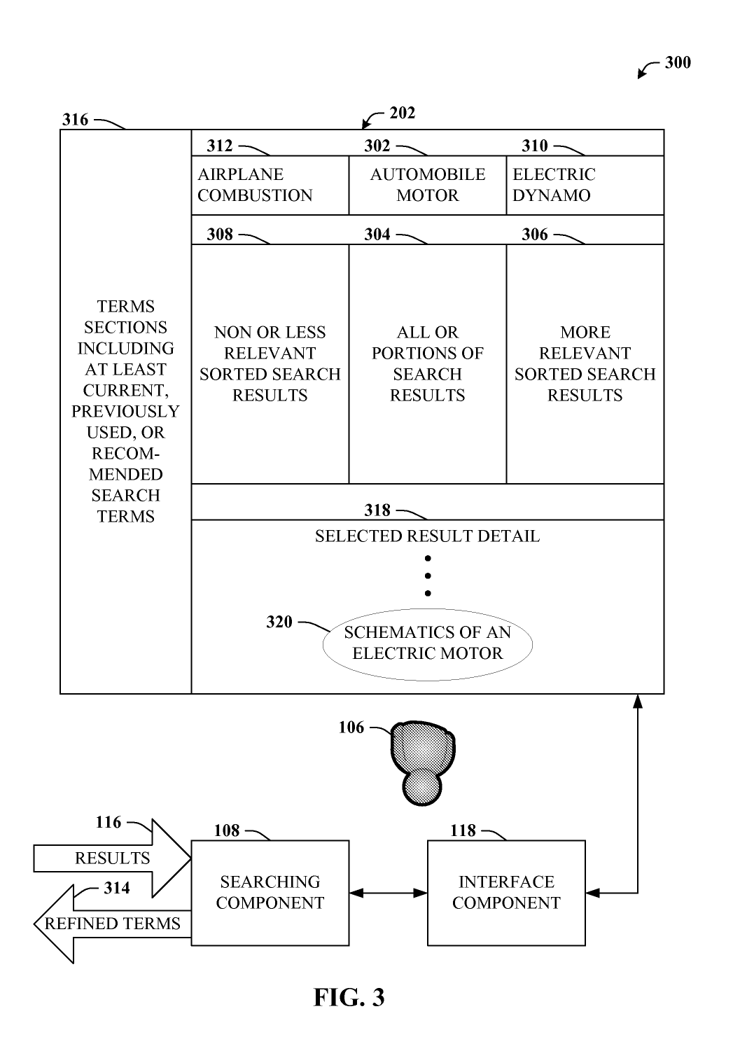

Additionally or alternatively, interface component 118 can display or present a distinct subset of search results 116 to various portions 202 of multi-touch surface 102 based upon selections or gestures provided by associated collaborative users 106. As one example, interface component 118 can display all or a portion of set 116 of search results to shared portion 206 (according to multiple queries sent to search engine 110 or based upon various set operators applied to set 114 of search terms by searching component 108). Subsequently, collaborative users 106 can grab or select (with physical gestures or tactile operations upon multi-touch surface 102) distinct fragments of those results and move the selected fragments to their own portion 202, leaving the remaining results 116 on shared portion 206, e.g. for other collocated users 106 to choose their own bits of data to work with. Shared portion 206 can also be employed to display search terms, either those that were previously used, currently used or recommended. Thus, such terms can be easily selected for a new search query without the need to type or retype search terms, as is further discussed in connection with FIG. 3.

Still referring to FIG. 1, but turning now also to FIG. 3, system 300 that can provide a variety of features in connection with a collaborative search on a portion of a multi-touch surface is depicted. Portion 202 is intended to represent an example illustration of one of the individual regions of multi-touch surface 102 interactively associated with by one of the collaborative users 106. In order to provide a succinct example illustration, consider a number of collaborative users 106 who are working together on related tasks associated with an electric/hybrid car. Consider the depicted user 106 performs a search query for “automobile motor,” as denoted by reference numeral 302. Search query 302 can represent set 114 of search terms, or can merely be the particular portion of set 114 contributed by user 106. Results to this query 302 (or other related queries according to set 114) can be displayed in the central region 304. User 106 can cursorily peruse these results 304 and quickly sort them according to, e.g. an apparent relevance to the task at hand.

In one or more aspects, searching component 108 can further refine set 114 (illustrated by refined terms 314) of search terms as one or more collaborative users 106 sorts all or a portion of set 116 of search results by way of tactile or gesture inputs in connection with multi-touch surface 102. For example, user 106 can quickly or conveniently slide non-relevant or less relevant results, say, to the left (e.g. into region 308), while sliding more relevant results or those that bear closer examination to the right (e.g. into region 306); all potentially with intuitive tactile-based gestures in connection with multi-touch surface 102. Moreover, based upon such or similar types of sorting, searching component 108 can further refine set 114 of search terms and/or query terms 302 to create refined terms 314 that can be delivered to search engine 110.

Such can be accomplished by, e.g., identifying certain keywords, topics or domains that can be distinguished between sorted members of more relevant results 306 and those of less relevant results 308. In particular, content, metatags, or other metadata relating to results can be analyzed to determine appropriate keywords, topics or domains. For instance, suppose, based upon the ongoing sorting described supra, searching component 108 is able to determine that collaborative user 106 is only interested in cars and/or is not interested in, say, airplane engines, or motors for any non-car automobile. Likewise, based upon the sorting, it is further determined that collaborative user 106 is not interested in combustion-based engines, but rather electric-based motors as well as inducing current from kinetic or mechanical sources as with dynamos. Thus, searching component 108 can lists 310 or 312 to further refine search terms 114 or search query 302. For example, keywords 310 can be employed to more specifically direct a search or query, whereas keywords 312 can be employed to indicate unwanted terms 114.

Furthermore, as introduced above, interface component 118 can maintain terms section 316 one multi-touch surface 102, where previous, current, or recommended search terms can be listed. Reference numeral 310 can be an example of recommended search terms or (along with regions 302 and 312) another example of a terms section 316. Such an area can be beneficial to a user of multi-touch surface 102 to minimize the frequency of key-based data entry (e.g., typing search terms). Rather, terms can be quickly and intuitively selected or moved from other parts of portion 202 or multi-touch surface 102, and submitted as a new or refined query 314. It should be appreciated that interface component 118 can provide a virtual or “soft” keyboard to collaborative user 106 for such purposes. Moreover, multi-touch surface 102 can in some cases include or be operatively coupled to a normal physical keyboard. However, surface-based computing is generally moving away from physical keyboards, yet users of soft keyboards (especially those who are familiar with conventional physical keyboards) often find them slightly unnatural. Accordingly, by providing terms section 316 as well as automatically refining search terms, key entry of search terms can be greatly reduced for collaborative users 106.

In one or more aspects of the claimed subject matter, interface component 118 can identify term selection gesture 320 associated with one or more terms displayed on multi-touch surface 102, while searching component 108 can refine set 114 of search terms to include the one or more terms identified by term selection gesture 320. For example, consider region 318 of portion 202, in which a selected result is displayed in detail. Thus, while user 106 sorts results 304 as described above, user 106 can also specifically select one of the results to examine in more detail, which can be presented in this example in region 318. While perusing the detailed results in region 318, user 106 can circle (or provide another suitable term selection gesture 320 such as underlining, including in brackets or braces . . . ) certain words or terms. Based upon this or another suitable term selection gesture 320, a search can be immediately enacted on the selected terms.

In one or more aspects of the claimed subject matter, searching component 118 can further refine set 114 of search terms as one or more collaborative users 106 merge results from set 116 of search results. For instance, user 106 can grab two results and visually bring those to results together to indicate, e.g., the types of results that are desired. Appreciably, interface component 118 can display or otherwise present a relationship between results from set 116 or between merged results. The relationship can be illustrated as lines or by way of a Venn diagram or with other charting features. Likewise, the relationship can be presented by way of pop-ups with relevant information or statistics.

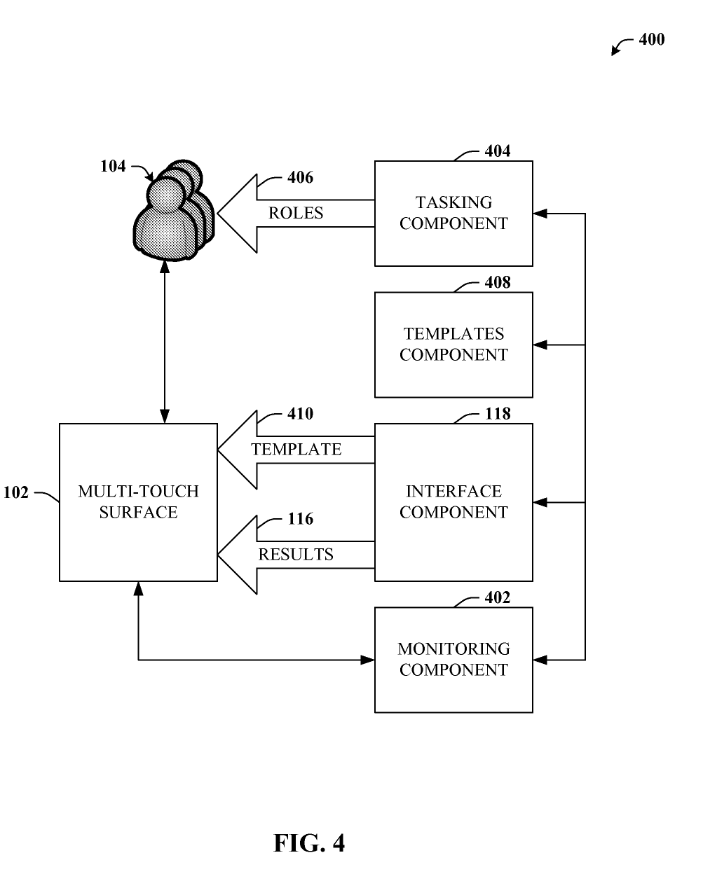

Referring now to FIG. 4, system 400 that can facilitate assignment of suitable roles and/or provide suitable templates for presenting results is illustrated. In general, system 400 can include interface component 118 that can present set 116 of search results by way of multi-touch surface 102 as well as other components included in system 100 or otherwise described herein. System 400 can also include monitoring component 402 that can infer at least one of an importance, a priority, or a productivity associated with a term from set 114 of search terms based upon activity in connection with the term or an associated search result (e.g., from search results 116 that specifically relate to the term). For example, suppose one or more collocated users 104 (or collaborative users 106) interacts with certain terms frequently or interacts frequently with results that stem from that term. In such a case, monitoring component 402 can assign a higher importance or priority to that particular term. However, if after an inordinate amount of time has passed without an apparent solution, then the productivity of that term can be lowered.

It should be appreciated that given the searches detailed herein are generally intended to relate to collaborations, various users 104 can specialize or be allocated specific tasks in connection with the collaborative searches. Accordingly, in one or more aspects of the claimed subject matter, system 400 can include tasking component 404 that can assign a suitable role 406 associated with a collaborative search to one or more collocated users 104. For example, one user 104 can be assigned a triaging job, to deal with an initially large number of results. This can include dividing portions of the returned results among many other collaborative users 106 or otherwise refining the output in some many. Similarly, a different user 104, 106 can be assigned tasks relating to refining the inputs in some way (e.g. refining the terms rather than the results). Appreciably, tasking component 404 can assign roles 406 based upon a user ID, based upon recent or historic activity of a user interacting with a particular portion 202 (which can be tracked by monitoring component 402), or in some other manner. It should be further appreciated that roles 406 can potentially be assigned to collocated user 104 who are not part of the collaborative search per se, and are therefore not necessarily defined as collaborative users 106, but rather can be more administrative in nature.

In one or more aspects of the claimed subject matter, system 400 can further include templates component 408. Templates component 408 can select a suitable output template 410 or diagram based upon at least one of set 114 of search terms or set 116 of search results. Upon suitable selection of output template 410, interface component can employ output template 410 for displaying or otherwise presenting set 116 of search results or portions thereof on multi-touch surface 102 in a graphical or topological manner consistent with output template 410. For instance, drawing once more from the example of a collaborative task relating to electric or hybrid cars introduced in connection with FIG. 4, based upon certain search terms 114 or search results 116, templates component can select output template 410 that visually depicts a car, potentially with portions exploded out to expose cross-sections or other details relating to various components. Overlaid on this template 410, results 116 can be presented at relevant locations such as placing search results 116 relating to a dynamo-based breaking system over wheels included in template 410, while results 116 relating to the electric motor over the hood or engine included in template 410. Of course, the above is merely one example and numerous other examples are envisioned or could be applicable as well.

Turning now to FIG. 5, network-accessible search engine system 500 that can leverage client-side capabilities including at least a collaborative search on a multi-touch surface in order to provide rich search results is provided. While much of the discussion thus far has been directed to client-side operations relating to collaborative search on multi-touch surface 102, the server or search engine side can be improved over conventional systems as well. In particular, system 500 can include example search engine 110. More particularly, search engine 110 can include acquisition component 502 that can receive set 504 of search terms, and can further receive multiuser surface identifier 506, which can be substantially similar to MSI 112 described supra.

For example, multiuser surface identifier 506 can indicate a variety of data by which, if properly configured, search engine 110 can leverage various client-side capabilities (e.g., client device 508, which can be, e.g., systems 100, 400 or combinations thereof). Accordingly, multiuser surface identifier 506 can indicate a collaborative search is requested, and thus, search engine 110 can be appraised, e.g. of the fact that multiple related queries can be received together or that refinements can be rapidly made. As another example, knowledge by search engine 110 that all queries originate from a multiuser scenario, substantially collocated and interacting with multi-touch surface 102 can be employed in connection with ad targeting. For instance, suppose one user 106 inputs a search term “jaguar.” At this point, an ad component included in or operatively coupled to search engine 110 might not be able to choose between car ads and ads for local zoos. However, if a second collaborative user 106 provides the term “ford,” then it can be more likely that car ads the appropriate domain.

Regardless, such information can aid search engine 110 in assigning jobs, allocating resources, structuring the search or the like. Moreover, multiuser surface identifier 506 can identify various output features of a client-side device 508, including at least that client-side device 508 includes a multi-touch surface (e.g., multi-touch surface 102). Moreover, multiuser surface identifier 506 can also include an indication of an origin for each term from set 504 of search terms. Accordingly, search engine 110 can be appraised of the number of related searches included in set 504 as well as the search term composition of each of those related searches versus the entire set 504.

Search engine 110 can also include transmission component 510 that can transmit to client-side device 508 set 512 of search results that correspond to set 504 of search terms. In addition, search engine 110 can include analysis component 514 that can select set 512 of search terms from indexed data store 516 based upon set 504 of search terms. Moreover, analysis component 514 can organize set 514 of search results based at least in part on the indication of origin for search terms 504 that is included in multiuser surface identifier 506.

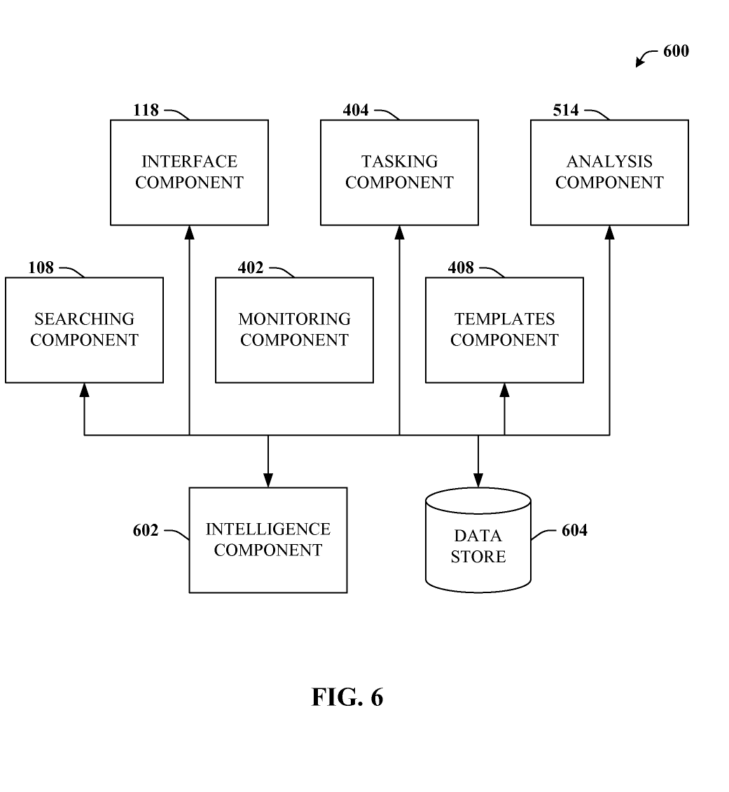

Referring now to FIG. 6, system 600 that can provide for or aid with various inferences or intelligent determinations is depicted. Generally, system 600 can include searching component 108, interface component 118, monitoring component 402, tasking component 404, templates component 408 or analysis component 514 as substantially described herein. In addition to what has been described, the above-mentioned components can make intelligent determinations or inferences. For example, searching component 108 can intelligently determine or infer common keywords or topics when refining or recommending search terms based upon an examination of content or metadata. Searching component 108 can also intelligently determine or infer set operators for merging or paring search terms. Likewise, interface component 118 can intelligently determine or infer orientations 204 associated with collocated users 104, where or how to display results 116 as well as interpreting various gestures, such as term selection gesture 320.

Similarly, monitoring component 402 can also employ intelligent determinations or inferences in connection with classifying importance, priority, or productivity. Tasking component 404 can intelligently determine or infer suitable roles 406 based upon historic data or interactivity, job title or hierarchy associate with a user ID, and so forth, whereas templates component 408 can intelligently determine or infer suitable template 410 based upon content, metadata or the like. Finally, analysis component 514 can intelligently determine or infer an organization for search results 512 based upon indicia included in multiuser surface identifier 506 or other suitable information. Appreciably, any of the foregoing inferences can potentially be based upon, e.g., Bayesian probabilities or confidence measures or based upon machine learning techniques related to historical analysis, feedback, and/or other determinations or inferences.

In addition, system 600 can also include intelligence component 602 that can provide for or aid in various inferences or determinations. In particular, in accordance with or in addition to what has been described supra with respect to intelligent determination or inferences provided by various components described herein. For example, all or portions of components 108, 118, 402, 404, 408, or 514 can be operatively coupled to intelligence component 602. Additionally or alternatively, all or portions of intelligence component 602 can be included in one or more components described herein. In either case, distinct instances of intelligence component 602 can exist such as one for use on the client side and another for use by analysis component 514 on the search engine side.

Moreover, intelligence component 602 will typically have access to all or portions of data sets described herein, such as data store 604. Data store 604 is intended to be a repository of all or portions of data, data sets, or information described herein or otherwise suitable for use with the claimed subject. Data store 604 can be centralized, either remotely or locally cached, or distributed, potentially across multiple devices and/or schemas. Furthermore, data store 604 can be embodied as substantially any type of memory, including but not limited to volatile or non-volatile, sequential access, structured access, or random access and so on. It should be understood that all or portions of data store 604 can be included in system 100, or can reside in part or entirely remotely from system 100.

Accordingly, in order to provide for or aid in the numerous inferences described herein, intelligence component 602 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

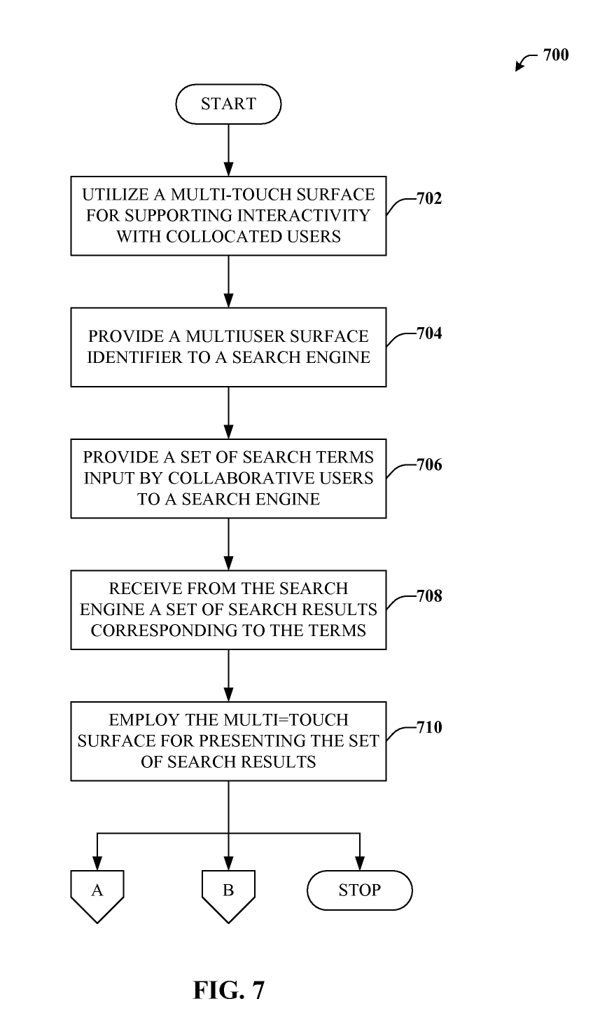

FIGS. 7, 8, and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 7, exemplary computer implemented method 700 for enriching collaborative searching features by leveraging a multi-touch surface display is illustrated. Generally, at reference numeral 702, a multi-touch surface can be utilized for supporting interactivity with multiple collocated users concurrently.

Furthermore, at reference numeral 704, a multiuser surface identifier can be provided to a search engine. Likewise, at reference numeral 706 a set of search terms input by collaborative users can be provided the search engine. Appreciably, the set of search terms can relate to a collaborative task shared by the collaborative users. The multiuser surface identifier can, inter alia, identify the fact that a collaborative search is occurring on a surface-based display.

Next to be described, at reference numeral 708, a set of search results corresponding to the set of search terms can be received from the search engine. At reference numeral 710, the multi-touch surface can be employed for presenting the set of search results to the collaborative users.

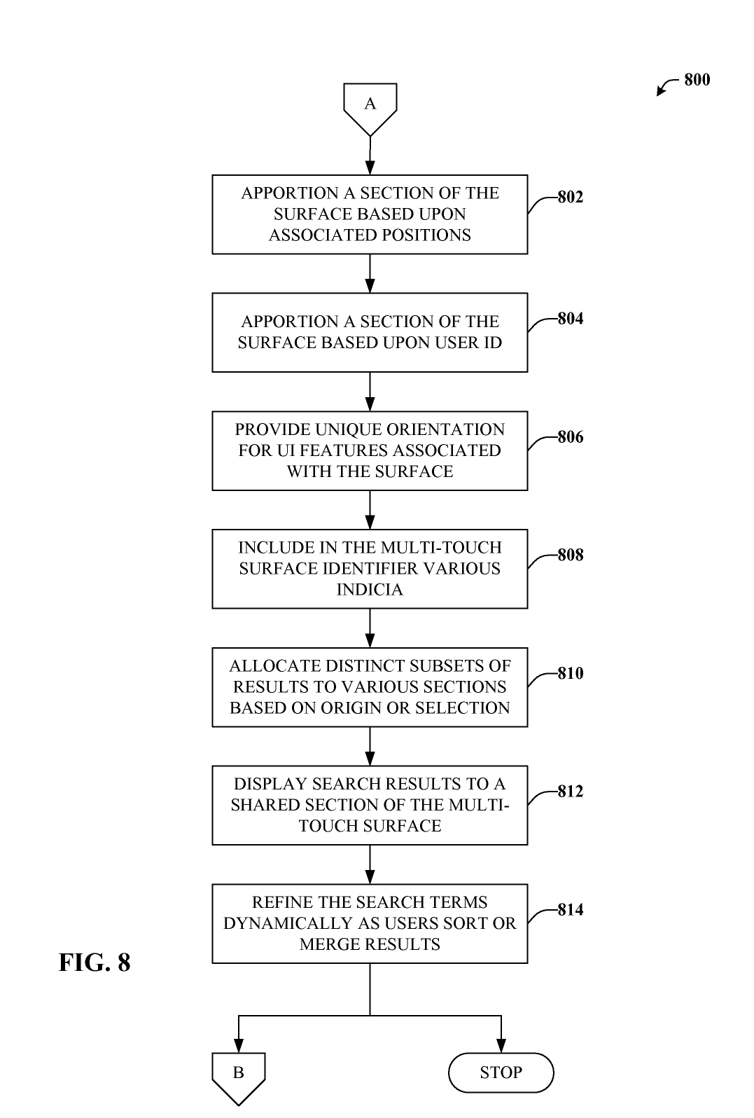

Referring to FIG. 8, exemplary computer implemented method 800 for apportioning the multi-touch surface and/or additional features associated with presenting results is depicted. At reference numeral 802, a section of the multi-touch surface can be apportioned to each of the collocated users based upon an associated position near to the multi-touch surface occupied by each of the collocated users, respectively. Similarly, at reference numeral 804, a section of the multi-touch surface can be apportioned to each of the collocated users based upon a user ID associated with each of the collocated users, respectively. Appreciably, these and other features can be provided by tactile-based gestures or interaction with the multi-touch surface by the collocated users.

At reference numeral 806, a unique orientation for user-interface features associated with each section of the multi-touch surface can be provided. For example, users sitting on opposite sides of the multi-touch surface can each be afforded an orientation for display features that is suitable to his or her position rather that attempting to mentally interpret data that is sideways or upside-down. As with the apportioning techniques described above, providing orientations can be based upon tactile-based inputs or gestures by the individual collocated users.

With reference to the multiuser surface identifier described at reference numeral 704, at reference numeral 808, an indication of at least one of a collaborative query, a surface specification, a current number of collocated or collaborative users, or an origin of each search term can be included in the multiuser surface identifier.

Moreover, potentially based upon this indicia or defining data, at reference numeral 810, distinct subsets of the search results can be allocated to various sections of the multi-touch surface. Such allocation can be based upon the origin of particular search terms or based upon selection input from one or more collaborative users. Furthermore, at reference numeral 812, all or a distinct subset of the search results can be displayed or presented to a shared section of the multi-touch surface. In more detail, users can select the subset of search results tactilely (e.g., from the shared surface) or distinct subsets can be automatically returned to suitable sections of the multi-touch surface associated with users who originated certain search term.

At reference numeral 814, the set of search terms can be dynamically refined as one or more collaborative users sort or merge the search results. In particular, by examining content, metatags, or other metadata included in results that are sorted (e.g., as relevant versus not relevant, or the like) or merged together, new keywords or search topics can be identified as more specific to the task or interest or, in contrast, identified as decidedly not specific.

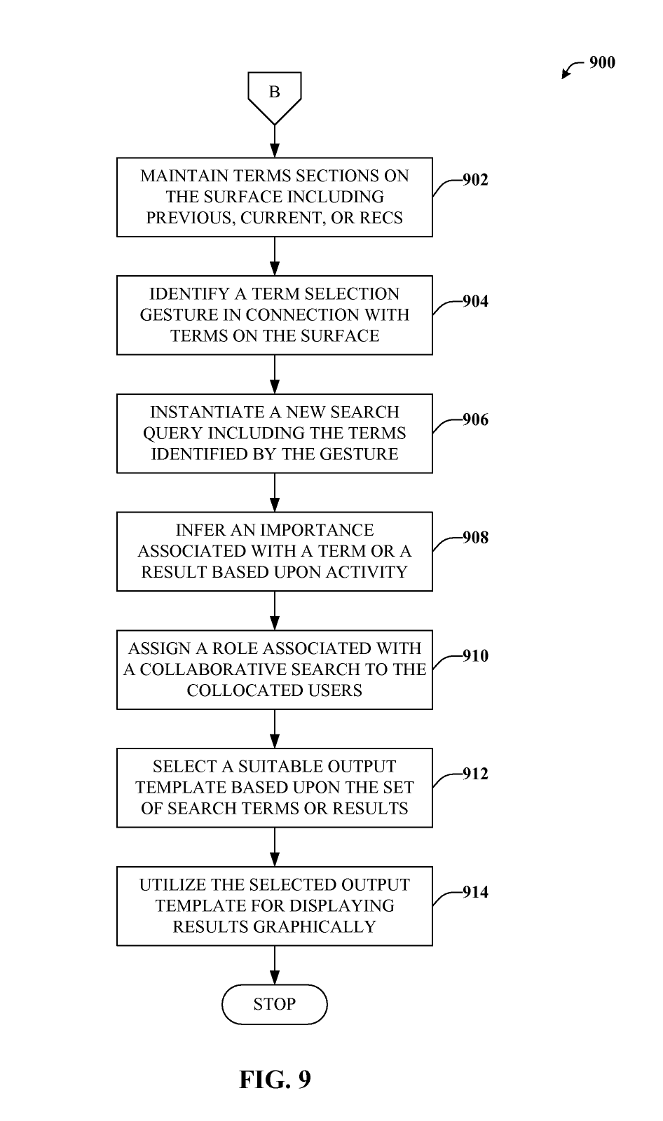

With reference now to FIG. 9, method 900 for providing addition features in connection with enriching surface-based collaborative searching is illustrated. At reference numeral 902, one or more terms sections can be maintained on the multi-touch surface including at least previous search terms, currently employed search terms, or recommended search terms. Appreciably, such terms section(s) can reduce text or typing-based inputs, which are often sought to be avoided by surface-based applications or associated users.

At reference numeral 904, a term selection gesture can be identified in connection with one or more terms displayed on the multi-touch surface. For example, when examining search results in detail or other features displayed on the multi-touch surface, the user can circle, underline, or encase particularly relevant terms in brackets (or some other suitable gesture) in order to specifically select those particular terms. Next, at reference numeral 906, a new or refined search query can be instantiated including the one or more terms identified by the term selection gesture discussed in connection with reference numeral 904.

In addition, at reference numeral 908, an importance or productivity associated with a term or a result that corresponds to various terms can be inferred based upon activity. For example, user activity in connection with the term can be monitored. Thus, terms or results that receive much touching or manipulation can be assigned higher importance than those that receive little or no activity. Moreover, a productivity threshold can also be included such that a high amount of activity associated with a term or result that yield little or no solution to a task can be identified as, e.g. an unproductive dead end.

At reference numeral 910, a role associated with a collaborative search can be assigned to one or more collocated users. Such roles can be assigned based upon current or historic activity, assigned based upon user IDs, or in substantially any suitable manner. Furthermore, at reference numeral 912, a suitable output template or diagram can be selected based upon the set of search terms or the set of search results. For instance, content or metadata can again be examined to determine the suitable template. Thus, at reference numeral 914, the selected output template or diagram can be utilized for displaying the set of search results in a graphical or topological manner.

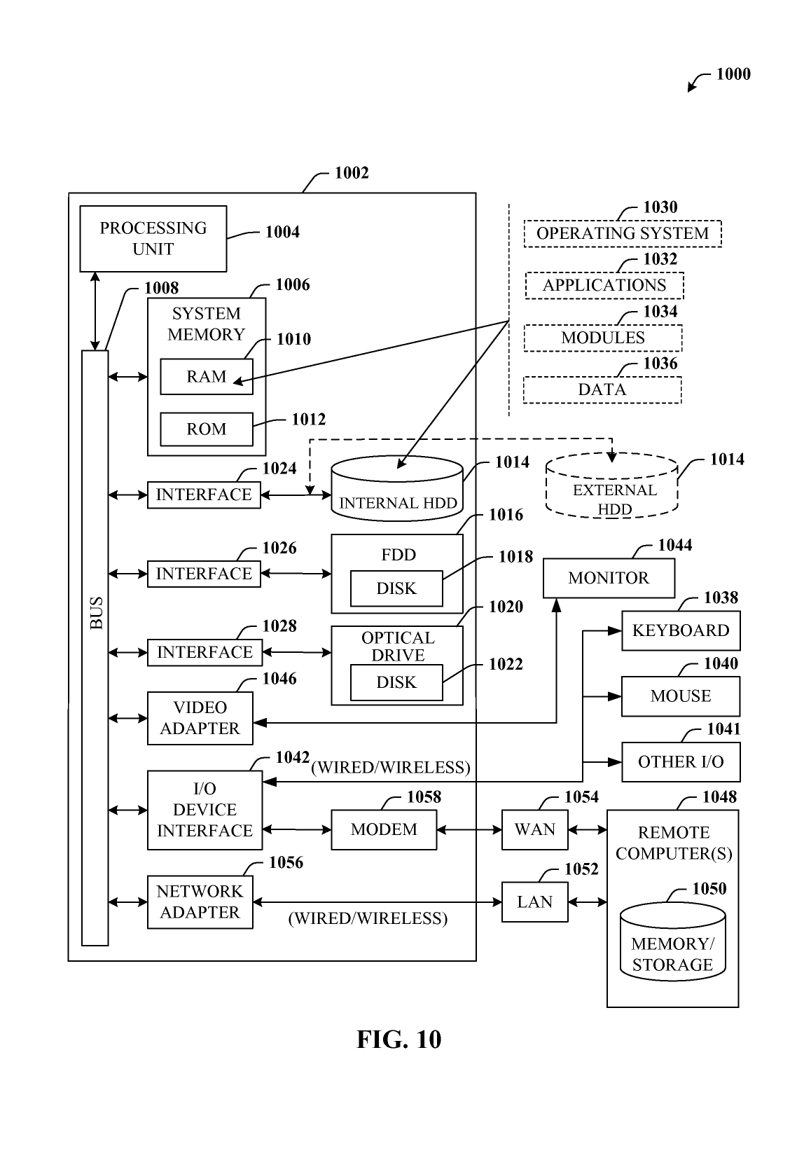

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices 1041 may include a speaker, a microphone, a camera or another imaging device, an IR remote control, a joystick, a game pad, a stylus pen, touch screen, or the like. These and other input devices are often connected to the processing unit 1004 through an input-output device interface 1042 that can be coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, a mobile device, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g. a wide area network (WAN) 1054. Such LAN and WAN networking environments are commonplace in offices and companies, and facilitate enterprise-wide computer networks, such as intranets, all of which may connect to a global communications network, e.g. the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 10 Mbps (802.11b) or 54 Mbps (802.11a) data rate, for example, or with products that contain both bands (dual band), so the networks can provide real-world performance similar to the basic “10 BaseT” wired Ethernet networks used in many offices.

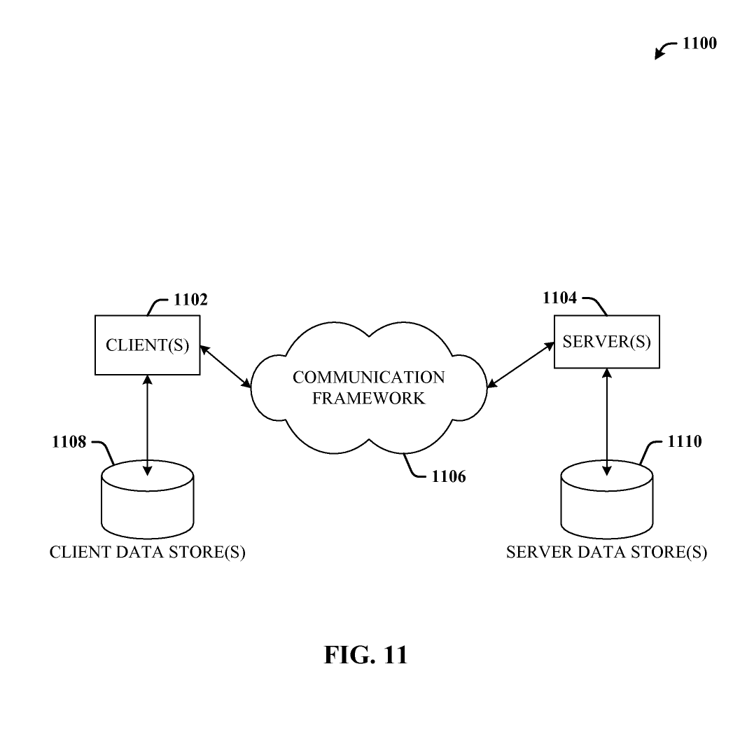

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer implemented system that leverages a multi-touch surface computing-based display to provide rich search features, comprising:
a multi-touch surface that is configured to support interactivity with multiple collocated users simultaneously;
a searching component that transmits to a search engine (1) a multiuser surface identifier, and (2) a set of search terms input by collaborative users that represent all or a portion of the collocated users, and that further receives a set of search results that correspond to the set of search terms; and
an interface component that presents the set of search results by way of the multi-touch surface.

2. The system of claim 1, each term from the set of search terms relates to a collaborative task shared by the collaborative users.

3. The system of claim 1, the interface component allocates a portion of the multi-touch surface to each of the collocated users (1) based upon an associated position around the multi-touch surface occupied by each of the collocated users, respectively, or (2) based upon a user ID associated with each of the collocated users, respectively; the interface component further provides a unique orientation for user-interface features associated with each portion of the multi-touch surface that is allocated to each collocated user.

4. The system of claim 1, the multiuser surface identifier is a flag or tag that indicates a collaborative query and relevant features associated with the multi-touch surface.

5. The system of claim 4, the multiuser surface identifier further identifies a portion of the multi-touch surface or a user ID associated with each term from the set of search terms.

6. The system of claim 1, the interface component automatically displays a distinct subset of search results to various portions of the multi-touch surface based upon distinct search terms provided by associated collaborative users.

7. The system of claim 1, the interface component displays a distinct subset of search results to various portions of the multi-touch surface based upon selections or gestures provided by associated collaborative users.

8. The system of claim 1, the searching component applies a union, an intersection, or a conjoin to various members of the set of search terms; and the interface component displays a distinct subset of search results to a shared portion of the multi-touch surface.

9. The system of claim 1, the searching component further refines the set of search terms as one or more collaborative users sort all or a portion of the results from the set of search results by way of touch or gesture inputs in connection with the multi-touch surface.

10. The system of claim 1, the searching component further refines the set of search terms as one or more collaborative users merge results from the set of search results.

11. The system of claim 1, the interface component displays a relationship between results from the set of search results or between merged results from the set of search results.

12. The system of claim 1, the interface component maintains a terms section on the multi-touch surface that includes previous, current, or recommended search terms.

13. The system of claim 1, the interface component identifies a term selection gesture associated with one or more terms displayed on the multi-touch surface or speech that characterizes one or more terms; and the selection component refines the set of search terms to include the one or more terms.

14. The system of claim 1, further comprising a monitoring component that infers at least one of an importance, a priority, or a productivity associated with a term from the set of search terms based upon activity in connection with the term or an associated search result.

15. The system of claim 1, further comprising a tasking component that assigns a suitable role associated with a collaborative search to one or more of the collocated users.

16. The system of claim 1, further comprising a templates component that selects a suitable output template or diagram based upon at least one of the set of search terms or the set of search results; the interface component employs the output template or diagram for displaying the set of search results in a graphical or topological manner.

17. A method for enriching collaborative searching features by leveraging a multi-touch surface display, comprising:
utilizing a multi-touch surface for supporting interactivity with multiple collocated users concurrently;
providing a multiuser surface identifier to a search engine;
providing a set of search terms input by collaborative users to the search engine;
receiving from the search engine a set of search results corresponding to the set of search terms; and
employing the multi-touch surface for presenting the set of search results.

18. The method of claim 17, further comprising at least one of the following acts:
apportioning a section of the multi-touch surface to each of the collocated users based upon an associated position near to the multi-touch surface occupied by each of the collocated users, respectively;
apportioning a section of the multi-touch surface to each of the collocated users based upon a user ID associated with each of the collocated users, respectively;
providing unique orientation for user-interface features associated with each section of the multi-touch surface;
including in the multiuser surface identifier an indication of at least one of a collaborative query, a surface specification, a current number of collocated or collaborative users, or an origin of each search term;
allocating distinct subsets of the search results to various sections of the multi-touch surface based upon the origin of particular search terms or based upon selection input from collaborative users;
displaying all or a distinct subset of the search results to a shared section of the multi-touch surface; or
refining the set of search terms dynamically as one or more collaborative users sort or merge the search results.

19. The method of claim 17, further comprising at least one of the following acts:
maintaining one or more terms sections on the multi-touch surface including at least previous, current, or recommended search terms;
identifying a term selection gesture in connection with one or more terms displayed on the multi-touch surface;
instantiating a new search query including the one or more terms identified by the term selection gesture;
inferring an importance associated with a term or a result based upon activity
assigning a role associated with a collaborative search to one or more of the collocated users
selecting a suitable output template or diagram based upon the set of search terms or the set of search results; or
utilizing the selected output template or diagram for displaying the set of search results in a graphical or topological manner.

20. A network-accessible search engine that leverages client-side capabilities including at least a collaborative search on a multi-touch surface to provide rich search results, comprising:
an acquisition component that receives a set of search terms, and further receives a multiuser surface identifier that indicates (1) a collaborative search is requested, (2) output features of a client-side device, including at least that the client-side device includes a multi-touch surface, and (3) an indication of an origin for each term from the set of search terms.
a transmission component that transmits to the client-side device a set of search results that correspond to the set of search terms; and
an analysis component that selects the set of search results from an indexed data store based upon the set of search terms, the analysis component organizes the set of search results based at least in part on the indication of origin for search terms.
